(19) United States
(12) Patent Application Publication
(10) Pub. No.: US 2017/0015041 A1
(43) Pub. Date: Jan. 19, 2017

(54) INJECTION MOLDING SYSTEM

(71) Applicant: FANUC Corporation, Yamanashi (JP)

(72) Inventor: Wataru SHIRAISHI, Yamanashi (JP)

(21) Appl. No.: 15/209,614

(22) Filed: Jul. 13, 2016

(30) Foreign Application Priority Data
Jul. 14, 2015 (JP) 2015-140533

(51) Int. Cl. B29C 45/80; B29C 45/14

(52) U.S. Cl. CPC B29C 45/80; B29C 45/14065; B29C 2945/76795; B29C 2945/76083; B29C 2945/76568

(57) ABSTRACT

Provided are a mirror-surface member configured to reflect an insert held by an insert moving means and an insertion position compensation means. An amount of misalignment between the insert and the insert moving means is calculated based on a photographed image of the insert reflected on the mirror-surface member, and an insertion position for the insert to be inserted into a mold is compensated based on the amount of misalignment.

### BACKGROUND OF THE INVENTION

Field of the Invention

The present invention relates to an injection molding system, and more particularly, to an injection molding system configured to perform injection molding after an insert is inserted into a mold of an injection molding machine.

Description of the Related Art

An injection molding machine employed in an injection molding system is used to perform insert molding in which injection molding is carried out with a mold closed after an insert is inserted into the mold.

As this is done, the inserted insert may be held misaligned with a target holding position, in some cases, and molding defects may possibly be caused if the molding is carried out in this state. Conventionally, therefore, automatic insertion operation, if any, for the insert is performed by an insertion device in the following procedure.

First, a first camera is located near a mounting position for the insert so that it can photograph the insert, and insert holding position information obtained by the photographing is output to the insertion device. The insertion device holds the insert based on the insert holding position information delivered thereto.

Then, the insertion device holding the insert is moved close to a second camera located in a predetermined position, and it is photographed by the second camera. Based on the result of the photographing, a compensation value is calculated by measuring the amount of deviation of the insert held by a hand portion of the insertion device from a reference position of the insert. Thereafter, the insert is inserted into the mold by controlling the insertion device for a position based on the consideration of the compensation value.

Japanese Patent Application Laid-Open No. 3-228589 discloses a positioning method for a workpiece used in a machine tool, based on a technique in which the position and posture of the workpiece conveyed by a conveying means are detected by capturing by a camera an image of the workpiece gripped and carried to the front of the camera by a robot.

In the conventional technique, however, the two cameras, first and second, are used to compensate the insert, and the arrangement of the two cameras may complicate the structure.

### SUMMARY OF THE INVENTION

Accordingly, the object of the present invention is to provide an injection molding system capable of accurately inserting an insert with a simple structure.

An injection molding system according to the present invention is configured to perform injection molding based on insert molding after an insert is inserted into a mold and comprises an insert moving means for holding the insert and inserting the insert into the mold, an insert photographing means provided on the insert moving means and configured to photograph the insert, an insert holding position calculation means configured to calculate holding position information on the insert held by the insert moving means, based on image data of the insert photographed by the insert photographing means, a mirror-surface member configured to reflect the insert held by the insert moving means, and an insertion position compensation means. The insertion position compensation means calculates an amount of misalignment between the insert and the insert moving means, based on the photographed image of the insert reflected on the mirror-surface member, and compensates an insertion position for the insert to be inserted into the mold, based on the amount of misalignment.

Thus, the insert can be photographed by only the single photographing means, so that the configuration of the injection molding system can be simplified. Further, only the single photographing means can properly compensate the insertion position for the insert, so that the insert can be inserted in a correct position and molding defects can be reduced.

The insert moving means may be a robot.

The injection molding system may comprise an insertion position compensation value storage means configured to be stored for each shot number with compensation value data on the insertion position for the insert compensated by the insertion position compensation means, along with a physical quantity related to molding by an injection molding machine.

Thus, insertion position information on the insert can be confirmed for each shot number if an investigation of a molding history of a molded article is needed later.

The injection molding system may comprise a display device on which the compensation value data compensated by the insertion position compensation means or a graph representing the compensation value data is displayed.

Thus, the compensation value data compensated by the position compensation means or the graph representing the compensation value data is displayed, so that the relationship between the shot number and the compensation value data can be confirmed by the display on the display device.

An alarm may be output when the compensation value data exceeds a preset tolerance.

Thus, the alarm is output when the compensation value data exceeds the preset tolerance, so that the occurrence of abnormality in the positions of a hand of an articulated robot and a camera and the like can be detected so that an operator can be warned or molding can be stopped thereby.

The mirror-surface member may be provided on at least one plane of an outer peripheral surface of the mold.

Thus, the mirror-surface member is provided on at least one plane of an outer peripheral surface of the mold, so that the insert can be subjected to position compensation in a position just before it is inserted into the mold. Therefore, as compared with the case in which the mirror-surface member is provided in any other position, the injection molding system can be constructed so that an insertion device is moved for a minimum distance and the cycle time for injection molding can be further reduced.

According to the present invention, there can be provided an injection molding system capable of accurately inserting an insert with a simple structure.

### BRIEF DESCRIPTION OF THE DRAWINGS

The above and other objects and features of the present invention will be obvious from the ensuing description of embodiments with reference to the accompanying drawings, in which:

FIG. 1 is a diagram showing a configuration of an injection molding system according to an embodiment of the present invention;

FIG. 2 is a schematic view showing the vicinity of an articulated robot, insert, and mold according to the embodiment of the present invention;

FIG. 3 shows a modification in which the installation position of a mirror-surface member is changed;

FIG. 4A shows an example of a table displayed on a display and showing the relationship between compensation values for individual shots and the weights of molded articles;

FIG. 4B shows an example of a graph displayed on the display and showing the relationship between the compensation values for the individual shots and the weights of the molded articles; and

FIG. 5 shows an example of display in which a warning alarm is output when the compensation value exceeds a tolerance.

### DETAILED DESCRIPTION OF THE PREFERRED EMBODIMENTS

This application is based upon and claims the benefit of priority from the prior Japanese Patent Application No. 2015-140533, filed Jul. 14, 2015, the entire contents of which are incorporated herein by reference.

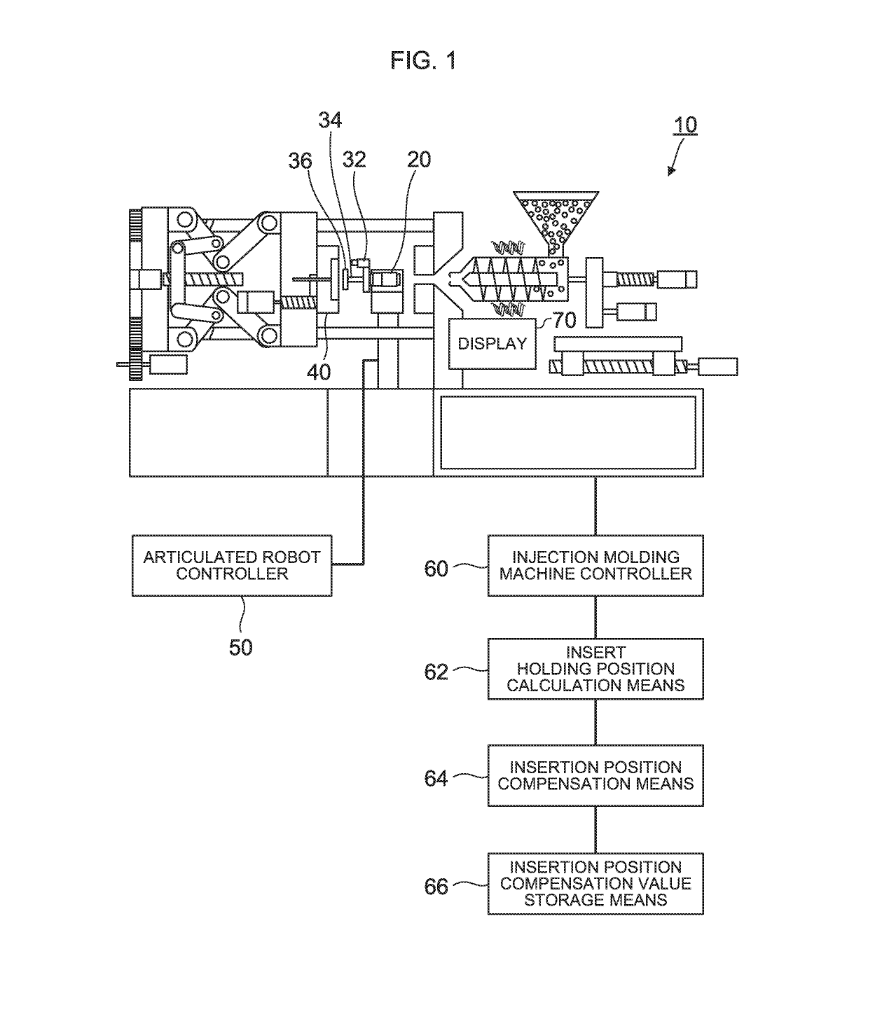

An embodiment of the present invention will now be described with reference to the accompanying drawings. FIG. 1 is a diagram showing a configuration of an injection molding system of the present invention embodiment. An injection molding machine 10 comprises a mold clamping device and an injection device. In the injection device, a resin stored in a hopper is fed into a cylinder and stirred and conveyed by a screw in the cylinder. Thereupon, the resin heat-melted in the cylinder is injected through a nozzle on the distal end of the cylinder.

The mold clamping device is provided with a mold 40 (comprising a fixed mold half and a movable mold half). After both the mold halves are closed, the resin is injected from the injection device into the mold 40. Thereafter, a molded article is ejected from the mold by an ejector.

A camera 32 and a hand 34 are provided on the distal end of an articulated robot 20. An insert 36 is held by the hand 34.

The injection molding machine 10 is connected with an injection molding machine controller 60, insert holding position calculation means 62, insertion position compensation means 64, and insertion position compensation value storage means 66. Further, the articulated robot 20 is connected with an articulated robot controller 50. While the insert holding position calculation means 62, insertion position compensation means 64, and insertion position compensation value storage means 66 are all connected to the injection molding machine 10 in the present embodiment, they may alternatively be connected to the articulated robot 20. Numeral 70 denotes a display attached to the injection molding machine 10.

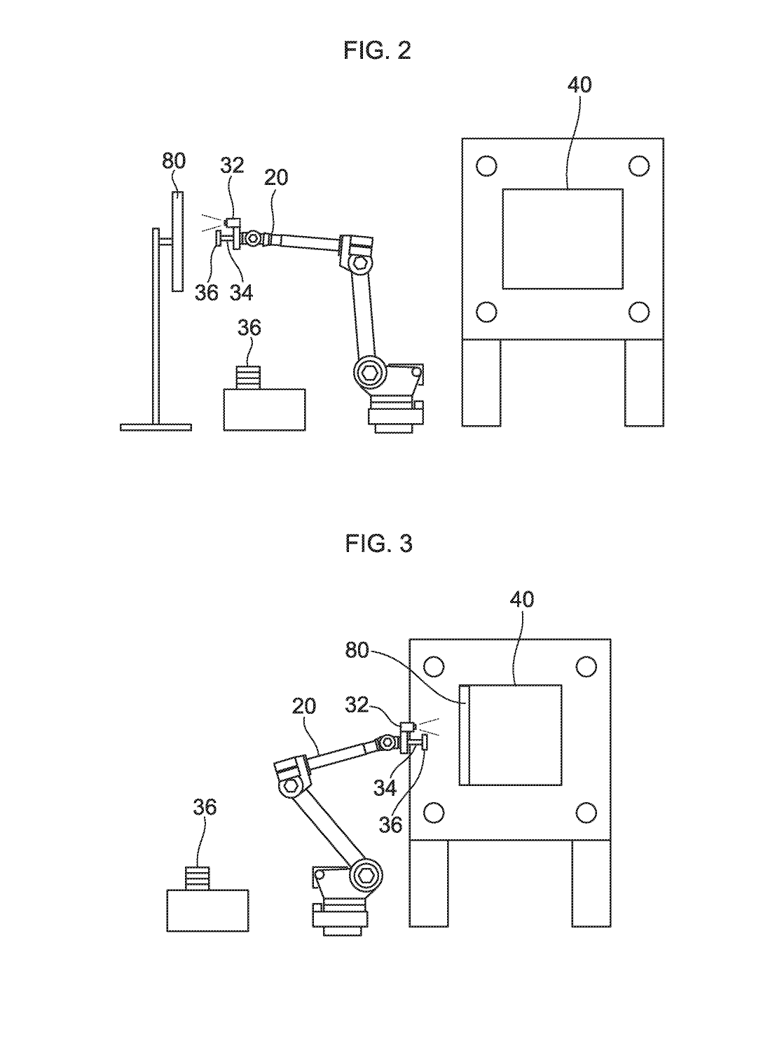

FIG. 2 is a schematic view showing the vicinity of the articulated robot 20, insert 36, and mold 40 according to the present embodiment. As mentioned before, the camera 32 and the hand 34 are provided on the distal end of the articulated robot 20. The insert 36 to be inserted into the mold 40 is previously mounted in a predetermined position and held in the mounting position by the hand 34. In holding the insert 36 by the hand 34, the insert 36 is photographed by the camera 32. Based on image data obtained by the photographing, position information for the hold of the insert 36 by the hand 34 is determined so that the insert 36 can be held by the hand 34.

After the insert 36 is held by the hand 34, the hand 34 holding the insert 36 is moved to the front of a mirror-surface member 80 by the articulated robot 20. In front of the mirror-surface member 80, an image of the hand 34 holding the insert 36 reflected on the mirror-surface member 80 is captured. Based on the captured image data, the amounts of deviation of the positions and inclinations of the insert 36 and the hand 34 are calculated. Thereafter, the hand 34 holding the insert 36 is moved to the mold 40 by the articulated robot 20 and the insert 36 is inserted into the mold 40 in consideration of the previously calculated amounts of deviation of the positions and inclinations.

Thus, if misalignment occurs as the hand 34 holds the insert 36, the insert 36 can be inserted into the mold 40 with the misalignment compensated. Since the installation position of the mold 40 is set in advance, the insert 36 can be inserted into the mold 40 without checking the installation position by the camera 32 or the like. While the mirror-surface member 80 may be located in any suitable position, moreover, it should preferably be located near a route in which the hand 34 of the articulated robot 20 holds and inserts the insert 36 into the mold 40.

FIG. 3 shows a modification in which the installation position of the mirror-surface member 80 is changed. In the present modification, the mirror-surface member 80 is provided on one surface of a flank portion of the mold 40. In particular, the surface that carries the mirror-surface member 80 thereon may be provided near a standby position such that the insert 36 to be inserted into the mold 40 waits just short of the standby position. If this is done, an image for calculating the amounts of deviation between the hand 34 and the insert 36 can be acquired. Thus, the articulated robot 20 need not assume any special behavior or posture for photographing, so that wasteful robot motion can be avoided.

While the mirror-surface member is assumed to be a planar one-piece member, moreover, a concave or convex mirror surface member may alternatively be used in order to enlarge an image for confirmation. Further, a plurality of mirror-surface members may be combined to reflect the molded article. By combining the plurality of mirror-surface members, moreover, the molded article can be photographed from various angles, and the insert 36 can be accurately inserted into the mold 40 even if it has a complicated shape, in particular.

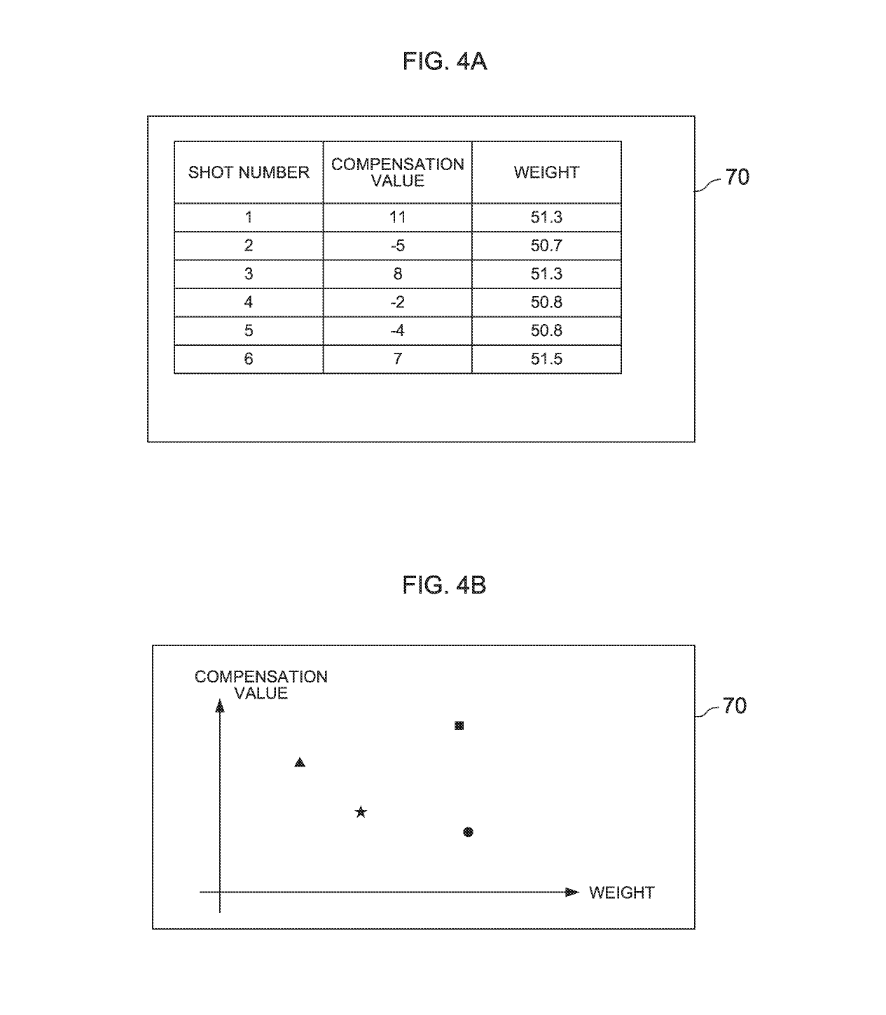

FIG. 4A shows an example of a table displayed on the display 70 and showing the relationship between compensation values for individual shots and the weights of molded articles. These compensation values and the weights of the molded articles are stored in the insertion position compensation value storage means 66 so that they correspond to one another for each shot. By previously acquiring these data, insertion position information on the insert and physical quantity data on the molded articles for each shot can be confirmed if an investigation of a molding history of a molded article is needed later.

Instead of the tabular display shown in FIG. 4A, moreover, the graph format shown in FIG. 4B may be displayed on the display 70.

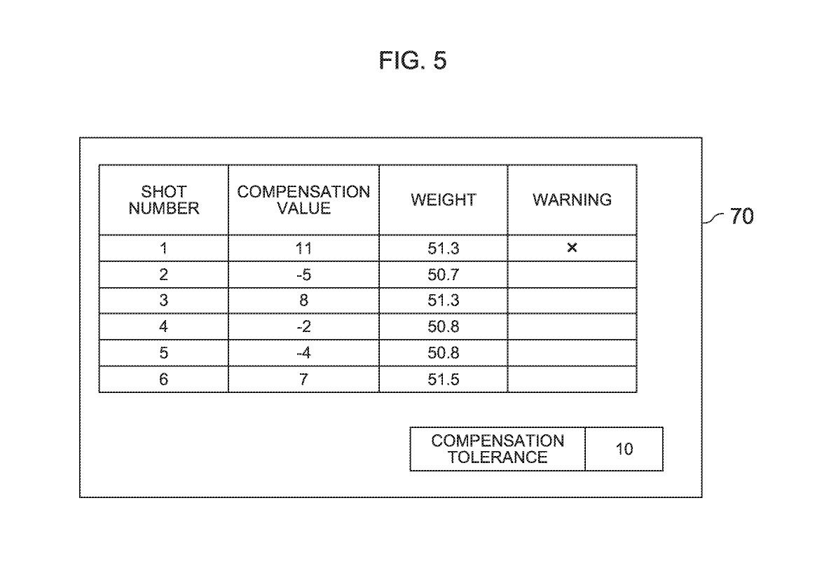

As shown in FIG. 5, furthermore, a tolerance for the compensation value may be set in advance so that an alarm can be output when the compensation value exceeds the set tolerance. Thus, the occurrence of abnormality in the positions of the hand 34 of the articulated robot 20 and the camera 32 and the like can be detected so that an operator can be warned or a molding operation can be stopped thereby. Instead of outputting the alarm when the tolerance is exceeded, moreover, the alarm may be output when the compensation value for each shot shows a specific tendency.

In calculating the amounts of deviation of the positions and inclinations of the insert 36 and the hand 34, moreover, the position of the hand 34 may be obtained from current position information of the articulated robot 20. In this case, the insert 36 should only be reflected on the mirror-surface member 80 as it is photographed so that its position and inclination can be calculated from image data.

Furthermore, a core may be used as the insert 36 to be inserted into the mold 40 according to the present embodiment.

1. An injection molding system configured to perform injection molding based on insert molding after an insert is inserted into a mold, the injection molding system comprising:
an insert moving means for holding the insert and inserting the insert into the mold;
an insert photographing means provided on the insert moving means and configured to photograph the insert;
an insert holding position calculation means configured to calculate holding position information on the insert held by the insert moving means, based on image data of the insert photographed by the insert photographing means;
a mirror-surface member configured to reflect the insert held by the insert moving means; and
an insertion position compensation means,
wherein the insertion position compensation means calculates an amount of misalignment between the insert and the insert moving means, based on the photographed image of the insert reflected on the mirror-surface member, and the insertion position compensation means compensates an insertion position for the insert to be inserted into the mold, based on the amount of misalignment.

2. The injection molding system according to claim 1, wherein the insert moving means is a robot.

3. The injection molding system according to claim 1, comprising an insertion position compensation value storage means configured to be stored for each shot number with compensation value data on the insertion position for the insert compensated by the insertion position compensation means, along with a physical quantity related to molding by an injection molding machine.

4. The injection molding system according to claim 3, comprising a display device on which the compensation value data compensated by the insertion position compensation means or a graph representing the compensation value data is displayed.

5. The injection molding system according to claim 3, wherein an alarm is output when the compensation value data exceeds a preset tolerance.

6. The injection molding system according to claim 1, wherein the mirror-surface member is provided on at least one plane of an outer peripheral surface of the mold.
